(19) United States
(12) Patent Application Publication
(10) Pub. No.: US 2019/0117518 A1
(43) Pub. Date: Apr. 25, 2019

(54) AIR-FREE, FLOW-CONTROL FEEDING BOTTLE

(71) Applicant: KHOA THO LE, WESTMINSTER, CO (US)

(72) Inventor: KHOA THO LE, WESTMINSTER, CO (US)

(73) Assignee: KHOA THO LE, WESTMINSTER, CO (US)

(21) Appl. No.: 15/984,435

(22) Filed: May 21, 2018

Related U.S. Application Data
(60) Provisional application No. 62/707,138, filed on Oct. 23, 2017.

(51) Int. Cl. A61J 11/00; A61J 11/04; A61J 11/02

(52) U.S. Cl. CPC A61J 11/0015; A61J 11/02; A61J 11/04

(57) ABSTRACT

A baby feeding bottle (1) comprising a cavity (2) adapted to hold a fluid; and a nipple (3) having an opening (4), the nipple (3) is coupled to the cavity, so as to allow the fluid to pass through the opening (4) of the nipple (3), wherein the nipple (3) further comprises a tube (5) which is placed within the nipple (3), and a sealed end (6) of the tube (5) is coupled to the opening of the nipple, and a free end (7) opposite to the sealed end (6) is having a flexible closure (8) adapted to be in an open position to allow the flow of the fluid on application of force onto an outer surface of the nipple (3), and to be in a closed position to disallow the flow of the fluid on removing the force onto the outer surface of the nipple (3). Embodiments including an assembly of the feeding bottle and method for using the feeding bottle is are also presented.

### CROSS-REFERENCE TO RELATED APPLICATIONS

This application claims priority to the U.S. Provisional Patent Application Ser. No. 62/707,138 entitled “Air-free, flow-control feeding bottle” filed on 23 Oct. 2017, the content of the said application have been incorporated herein in its entirety.

### FIELD OF THE INVENTION

The present invention relates to feeding bottles for children especially a baby. More specifically it relates to a feeding bottle which provides for mechanism for controlling the flow of the fluid present within the feeding bottle.

### BACKGROUND OF THE INVENTION

Baby bottles also called as nursing or feeding bottles are primarily used by infants and toddlers. The bottle is provided with a teat/nipple which allows the baby to drink directly from the bottle by sucking on the teat/nipple provided. It is often observed that even after the baby has stopped sucking on the nipple, the fluid present within the bottle continues to flow out; this causes an overflow of the fluid in the baby's mouth, nose and even ears leading to nose/ear infections. This happens because the feeding bottles do not have any kind of flow control mechanism that would prevent the fluid present within the feeding bottles from being dispensed when the baby is not actively sucking from the bottle. The feeding bottles presently available in the market do not have any provision for prevention of air ingestion when the baby is drinking from the bottle. Due to this, after feeding the back of the baby needs to be patted so that the air which has been ingested is released by burps. If the ingested air remains in the baby's stomach, it could lead to stomach upset and indigestion.

The aforementioned problems are addressed in the present invention which provides for a feeding bottle which provides for a flow control mechanism that restricts the fluid dispensed from bottle and also ensures that the no air bubbles are formed in the contained fluid by restricting the air flow into the bottle.

### SUMMARY OF THE INVENTION

According to an embodiment of the invention, a baby feeding bottle comprises of a cavity adapted to hold a fluid and a nipple having an opening, the nipple is coupled to the cavity, so as to allow the fluid to pass through the opening of the nipple. The nipple is further provided with a tube which is placed within the nipple, and a sealed end of the tube is coupled to the opening of the nipple, and a free end opposite to the sealed end is having a flexible closure adapted to be in an open position to allow the flow of the fluid on application of force onto an outer surface of the nipple, and to be in a closed position to disallow the flow of the fluid on removing the force onto the outer surface of the nipple.

According to another embodiment, the baby feeding bottle comprise of two parts, a first part comprising the cavity to hold the fluid and a second part comprising a nipple having the opening, such that when the first part is coupled to the second part, the fluid is allowed to pass through the opening of the nipple.

According to yet another embodiment, the baby feeding bottle has a flexible closure which is provided through a cut in the tube at the free end, such that the cut remains in the closed position when the force is not applied onto the outer surface of the nipple, and the cut moves into the open position, when the force is applied onto the outer surface of the nipple.

According to a further embodiment, the cut in the tube of the baby feeding bottle is provided in a length wise fashion from the free end and towards the sealed end.

According to yet another embodiment of the baby feeding bottle, the cut is up to one third of the length of the tube.

According to one embodiment of the baby feeding bottle, the flexible closure is adapted to be in the open position when a force is applied onto the outer surface of the nipple.

According to a further embodiment of the baby feeding bottle, the flexible closure is adapted to be in the open position when an axial force is applied onto the outer surface of the nipple

According to another embodiment of the baby feeding bottle, the nipple comprises one or more air vents to allow a flow of air into the nipple, and to disallow the flow of air out of the nipple in order to prevent air bubbles from being formed inside the nipple.

According to one embodiment, the baby feeding bottle has a flow control mechanism adapted to control flow of fluid from the cavity of the first part into the nipple.

According to another embodiment of the baby feeding bottle, the flow control mechanism comprises two pieces, a first piece comprising a set of holes of increasing perimeters circumferentially placed, and a second piece having a cutout such that when the second piece placed onto the first piece, a selection of holes from the set are exposed, wherein the two pieces are coupled to the first part and the second part, so that to establish the flow of the fluid through the selection of the holes exposed.

According to a further embodiment of the feeding bottle, the second piece comprises more than one cutout symmetrically placed into the second piece.

According to another embodiment of the feeding bottle, the second piece comprises three cutouts of equal parameter symmetrically placed, such that forming three portions from the remaining part of the second piece, and each portion is of equivalent perimeters to that of the cutouts, the portions are alternatively placed with respect to the cutouts.

According to one embodiment of the feeding bottle, an actuator for controlling the flow control mechanism is provided.

According to a further embodiment of the feeding bottle, the actuator is provided on either an outer surface of the first part or the second part.

According to another embodiment of the feeding bottle, a lock is coupled to the actuator and is adapted to lock the actuator for controlling the flow control mechanism.

According to yet another embodiment of the feeding bottle, a flow control reading embossed in proximity to the actuator on either an outer surface of the first part or the second part, the flow control reading indicates for a particular movement of the actuator shall result in a particular flow control.

According to one embodiment, a baby feeding bottle assembly having a first part comprising a cavity adapted to hold a fluid and a second part comprises a nipple having an opening, such that when the first part is coupled to the second part, the fluid is allowed to pass through the opening of the nipple. The nipple further comprises a tube which is placed within the nipple, a sealed end of the tube is coupled to the opening of the nipple, and a free end opposite to the sealed end is having a flexible closure adapted to be in an open position to allow the flow of the fluid on application of force onto an outer surface of the nipple, and to be in a closed position to disallow the flow of the fluid on removing the force onto the outer surface of the nipple. One or more air vents allow a flow of air into the nipple, and to disallow the flow of air out of the nipple in order to prevent air bubbles from being formed inside the nipple. A flow control mechanism is adapted to control flow of fluid from the cavity of the first part into the nipple.

According to another embodiment, a method of using a feeding bottle comprises assembling a first part of the feeding bottle onto a second part of the feeding bottle, wherein the first part comprising a cavity adapted to hold a fluid, and the second part comprising a nipple having an opening, such that when the first part is coupled to the second part, the fluid is allowed to pass through the opening of the nipple. The nipple further comprises of a tube which is placed within the nipple, a sealed end of the tube is coupled to the opening of the nipple, and a free end opposite to the sealed end is having a flexible closure adapted to be in an open position to allow the flow of the fluid on application of force onto an outer surface of the nipple, and to be in a closed position to disallow the flow of the fluid on removing the force onto the outer surface of the nipple. The nipple of the bottle is placed into a feeding position so that the fluid moves up to the nipple from the cavity.

According to yet another embodiment of the method for using a feeding bottle, an actuator is used for actuating a flow control mechanism, for controlling flow of fluid from the cavity of the first part into the nipple.

According to a further embodiment of the method for using a feeding bottle, the actuator is locked using a lock coupled to the actuator.

### BRIEF DESCRIPTION OF THE FIGURES

FIG. 1 illustrates the components of the baby feeding bottle

FIG. 2 illustrates the air vents provided in the baby feeding bottle

FIG. 3 illustrates the flow control mechanism of the baby feeding bottle

### DETAILED DESCRIPTION OF THE PREFERRED EMBODIMENTS

The best and other modes for carrying out the present invention are presented in terms of the embodiments, herein depicted in drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced item.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

The present invention focuses on providing a baby feeding bottle with a flow control mechanism which prevents dispension of the fluid from the bottle when the baby is not stops the action of sucking on the nipple of the bottle. The baby feeding bottle provides for a mechanism for preventing the formation of air bubbles in the fluid which is contained in the bottle.

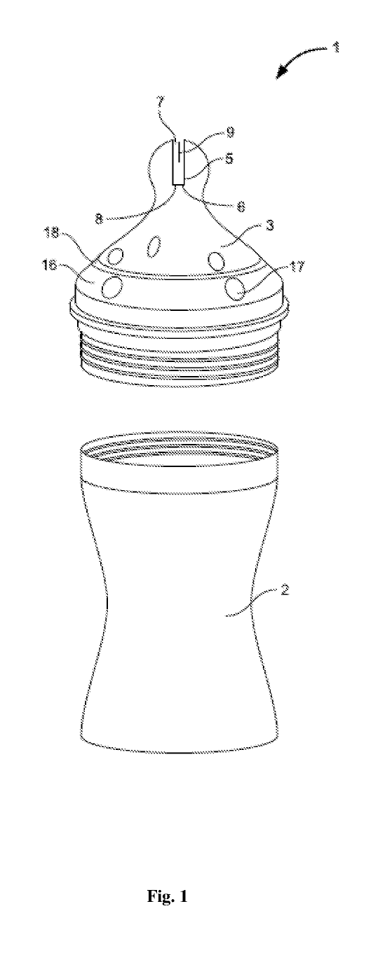

In one implementation of the invention as shown in FIG. 1, the baby bottle feeder 1 comprises a cavity 2 which is adapted to hold a fluid and a nipple 3 having an opening 4. The nipple 3 is coupled to the cavity 2 so that the fluid which is present in the cavity can flow from the opening 4 present on the nipple 3. A tube 5 which is placed within the nipple 3 and is coupled with the opening 4 so that fluid can be drawn out from the cavity when a baby applies pressure on the nipple 3 by sucking on it. The tube 5 has two openings, a sealed end 6 and a free end 7; the sealed end 6 of the tube 5 is connected to opening 4 of the nipple while the free end 7 of the tube 5 has a flexible closure 8. The components of the baby feeding bottle facilitate the effective functioning of the flow control mechanism which shall be described further.

The flexible disclosure 8 is adapted to be in an open position when pressure/force is applied to the outer surface of the nipple 3. The pressure/force mentioned is generated when the baby performs sucking action on the nipple 3 of the baby feeder bottle 1. When the baby stops sucking on the nipple, the external pressure/force is removed this causes the flexible disclosure to revert to a closed position. This ensures that no fluid is dispensed from the cavity of the bottle irrespective of the position in which the bottle has been placed.

The nipple 3 is made of medical silicone and the size of nipple 2 is half that of the baby's mouth so that the baby doesn't have suckling on the nipple 3 and no damage is caused to the baby's mouth. The baby feeder bottle 1 is made of medical plastics safe for use of babies. The baby feeder bottle is slightly curved in structure so that the baby can hold onto the bottle when ingesting the fluid from the bottle. For the feeding bottle to be operational, the nipple 3 and the cavity 2 have to be assembled together so that the fluid contained in cavity 2 can flow to the baby's mouth when the baby suckles on the nipple 3. The components of the feeding bottle also include a cover for the nipple so as to prevent dust and grime from coming into contact with the nipple. The body of the feeder bottle is also provided with a level indicator for showing the measure of the fluid in the cavity 2 of the bottle.

When the baby sucks on the nipple 3, the tongue presses the nipple 2 towards the palette of the baby's mouth which causes the flexible closure 8 to be moved to an open position such that the fluid can flow from the cavity 2 to the baby's mouth. The flow of fluid from the cavity 2 is facilitated by a cut 9 which is provided at the free end 7 of the tube 5 present in the nipple 3. When no pressure/force is being applied, the cut remains in a closed position to prevent the flow of milk from the cavity 2 to the baby's mouth. In a preferred embodiment, the length of the cut 9 is approximately one-third of the tube's 5 length and is made in a vertical (length wise) fashion, however the length of the cut 9 may vary such that is slightly lesser than or more than the one-third length specified. The assembly of the nipple 3 and cavity 2 is facilitated by a cap which has a threaded neck and can be screwed onto the neck of the feeder bottle. The cap ensures that there is no leakage of fluid from the bottle's neck or bottom of the nipple 2.

The baby feeding bottle 1 is provided with an actuator 16 for controlling the flow control mechanism, the said actuator maybe present either on the outer surface of the nipple 3 or the cavity 3 as per the production requirement. Further the actuators 16 is provided with a lock 17 so as to secure the actuator and prevent accidental tampering to the flow control mechanism once it has been set. In an alternate embodiment, there may be no actuator present for the flow control mechanism such that it needs to be set by the user manually at a certain flow rate. In another alternate embodiment, there may be no lock provided for the actuator thereby requiring manual vigilance to prevent tampering of the actuator.

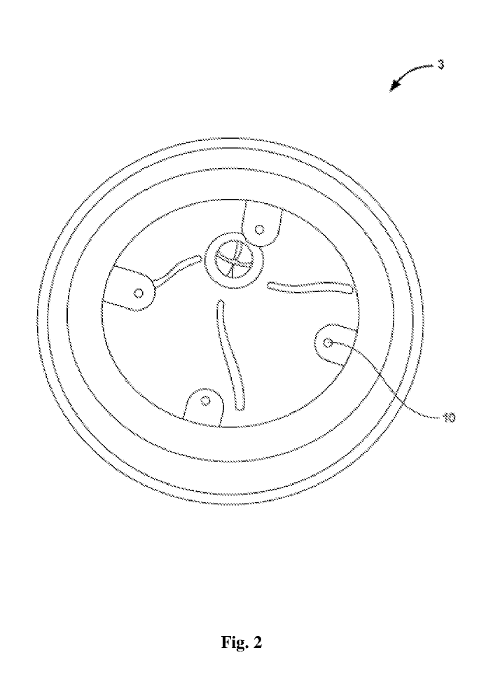

As shown in FIG. 2, the nipple 3 which is a component of the baby feeding bottle 1 is provided with one or more air vents 10. When the baby sucks on the nipple 3 of the feeder bottle, due to the suction the nipple 3 tends to contract slightly to facilitate the flow of fluid from the bottle to the baby's mouth. Once the baby stops sucking on the nipple, the nipple reverts to its original shape. The air vents 10 which are provided in the nipple 3 only allow the air to enter the bottle; it does not allow any air to be discharged from the feeder bottle thereby eliminating the possibility of air bubbles being formed in the fluid contained in the cavity. When the baby is ingesting fluid from the bottle, the fluid in the cavity is devoid of any air thus ensuring that the baby will not ingest any air along with the meal to cause ingestion/stomach upset for the baby.

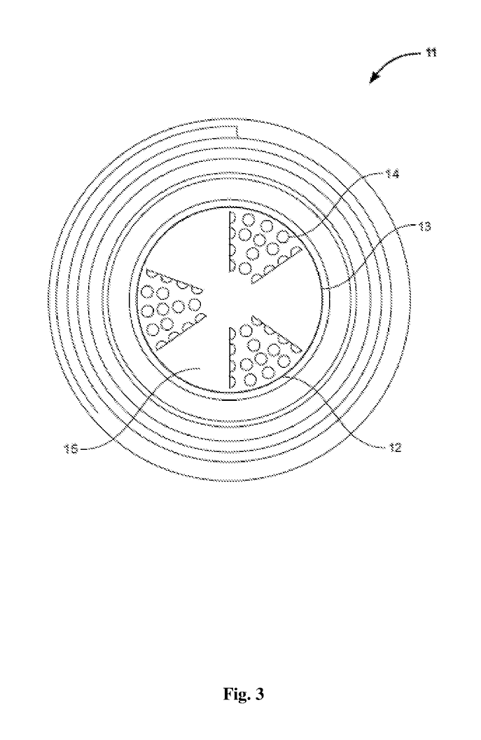

FIG. 3 illustrates the flow control mechanism for determining the flow control of fluid from the bottle. The feeder bottles available in the market do not provide any mechanism for controlling the flow control of the fluid that the baby is ingesting. The flow control of fluid from a normal feeder bottle is dependent on the pressure/force that the baby applies when sucking on the nipple of the feeder bottle, the stronger the pressure/force applied for sucking—the higher will be the flow control of the fluid. This is problematic as ingesting the fluid too fast could cause overflow of the milk from the baby's mouth or choking wherein the milk may enter the nose causing considerable discomfort to the baby. The flow control mechanism 11 is adapted to control the flow of fluid from the cavity of the bottle to the nipple so that the baby can ingest the fluid. The flow control mechanism 11 comprises of two pieces—a first piece 12 and a second piece 13.

The first piece 12 is provided with set of holes 14 which increase in diameter as they reach the circumference of the bottle while the second piece 13 is provided with a cutout 15. There maybe be more than one cutouts placed symmetrically into the second piece to ensure better flexibility. In a preferred embodiment of the invention, the flow control mechanism 11 comprises of 3 first pieces 12 and 3 second pieces 13 alternate with each other wherein the first pieces 12 are fixed while the second pieces 13 are movable. The second pieces 13 move onto the first pieces 12 such that the set of holes 14 are revealed to allow the flow of fluid from the cavity to the nipple. In an alternate embodiment, the first pieces 12 and the second pieces 13 may be more in number so that the fluid dispensed from the cavity of the fluid can be restricted further.

When the first pieces 12 and second pieces 13 are in a closed position, no fluid reaches the nipple from the cavity. Based on the flow control determined, the first and second pieces 12, 13 open in ranges of small, medium or complete opening for dispensing of the fluid from the cavity. An actuator is provided to facilitate the operation of the second pieces 13 which may be locked to prevent any accidental motion of the actuator by the baby or user.

The flow control for the dispension of the fluid can be determined by the user, by checking the flow control reading to determine whether the flow control should be slow, fast or optimal. The optimal flow control would facilitate the user in ensuring that the fluid dispensed from the cavity does not overflow or underflow causing discomfort to the baby. Alternatively, the user may set the flow control at a specific rate for the baby, this flow control may not necessarily be the optimal flow control.

Before utilizing the baby feeder bottle, the user has to ensure that all the components of the feeder bottle have been sufficiently cleaned and sterilized. Prior to use, the user assembles the nipple with the cap and ensures that the first and second pieces of the flow control mechanism are closed. The cap is then screwed onto the neck of the bottle, now the user can utilize the actuator to adjust the flow control based on flow control reading, lock the actuator using the lock provided with the actuator and provide the bottle to the baby. When the baby applies pressure/force on the nipple, the flexible closure present at the free end of the tube present in the nipple to be opened so as to allow the fluid to flow from the cavity to the baby mouth. The air vents provided in the nipple allow air to enter the bottle thereby eliminating any residual air in the fluid which the baby ingests. Once the baby stops applying pressure/force on the flexible closure returns to a closed position to prevent overflow of milk in the baby's mouth.

After the feeding, the feeding bottle can be easily disassembled and cleaned by submerging the components in warm water with soap for 15 mins, rinsing them with fresh water then washing them in boiling water for another 10 mins to ensure adequate sterilization so that the feeder bottle is ready for next use.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

### LIST OF REFERENCE NUMERALS

1 baby feeding bottle
2 cavity
3 nipple
4 opening of the nipple
5 tube placed in nipple
6 sealed end of tube
7 free end of tube
8 flexible closure
9 cut in the tube
10 air vent(s)
11 flow control mechanism
12 first piece
13 second piece
14 holes
15 cutout
16 actuator
17 lock
18 flow control reading

I claim:

1. A baby feeding bottle (1) comprising:
a cavity (2) adapted to hold a fluid; and
a nipple (3) having an opening (4), the nipple (3) is coupled to the cavity, so as to allow the fluid to pass through the opening (4) of the nipple (3),
wherein the nipple (3) further comprises a tube (5) which is placed within the nipple (3), and a sealed end (6) of the tube (5) is coupled to the opening of the nipple, and a free end (7) opposite to the sealed end (6) is having a flexible closure (8) adapted to be in an open position to allow the flow of the fluid on application of force onto an outer surface of the nipple (3), and to be in a closed position to disallow the flow of the fluid on removing the force onto the outer surface of the nipple (3).

2. The baby feeding bottle (1) according to the claim 1 comprising two parts:
a first part comprising the cavity (2) to hold the fluid; and
a second part comprising a nipple (3) having the opening (4), such that when the first part is coupled to the second part, the fluid is allowed to pass through the opening of the nipple (3).

3. The baby feeding bottle (1) according to claim 1, wherein the flexible closure (8) is provided through a cut (9) in the tube (5) at the free end, such that the cut (9) remains in the closed position when the force is not applied onto the outer surface of the nipple (3), and the cut (9) moves into the open position, when the force is applied onto the outer surface of the nipple (3).

4. The baby feeding bottle (1) according to claim 3, wherein the cut is (9) provided in a length wise fashion from the free end (7) and towards the sealed end (6).

5. The baby feeding bottle (1) according to claim 4, wherein the cut (9) is up to one third of the length of the tube (5).

6. The baby feeding bottle (1) according to the claim 1 the flexible closure (8) is adapted to be in the open position when an axial force is applied onto the outer surface of the nipple (3).

7. The baby feeding bottle (1) according to claim 1, wherein the nipple (3) comprises one or more air vents (10) to allow a flow of air into the nipple (3), and to disallow the flow of air out of the nipple (3) in order to prevent air bubbles from being formed inside the nipple (3).

8. The baby feeding bottle (1) according to claim 1 comprising a flow control mechanism (11) adapted to control flow of fluid from the cavity (2) of the first part into the nipple (3).

9. The baby feeding bottle (1) according to claim 8, wherein the flow control mechanism (11) comprises two pieces, a first piece (12) comprising a set of holes (14) of increasing perimeters circumferentially placed, and a second piece (13) having a cutout (15) such that when the second piece (13) placed onto the first piece (12), a selection of holes (14) from the set are exposed, wherein the two pieces (12, 13) are coupled to the first part and the second part, so that to establish the flow of the fluid through the selection of the holes exposed.

10. The baby feeding bottle (1) according to claim 9, wherein the second piece (13) comprises more than one cutout (15) symmetrically placed into the second piece (13).

11. The baby feeding bottle (1) according to claim 10, wherein the second piece (13) comprises three cutouts (15) of equal parameter symmetrically placed, such that forming three portions from the remaining part of the second piece (13), and each portion is of equivalent perimeters to that of the cutouts (15), the portions are alternatively placed with respect to the cutouts (15).

12. The baby feeding bottle (1) according to claim 8 comprising an actuator (16) for controlling the flow control mechanism (11).

13. The baby feeding bottle (1) according to claim 12, the actuator (16) is provided on either an outer surface of the first part or the second part.

14. The baby feeding bottle (1) according to claim 12 comprising a lock (17) coupled to the actuator (16) and adapted to lock the actuator (16) for controlling the flow control mechanism (11).

15. The baby feeding bottle (1) according to claim 12 comprising a flow rate reading (18) embossed in proximity to the actuator (16) on either an outer surface of the first part or the second part, the flow rate reading (18) indicates for a particular movement of the actuator (16) shall result in a particular flow rate.

16. A baby feeding bottle (1) assembly comprising:
a first part comprising a cavity (2) adapted to hold a fluid;
a second part comprising a nipple (3) having an opening (4), such that when the first part is coupled to the second part, the fluid is allowed to pass through the opening (4) of the nipple (3), the nipple (3) further comprising
a tube (5) which is placed within the nipple (3), a sealed end (6) of the tube (5) is coupled to the opening (4) of the nipple (3), and a free end (7) opposite to the sealed end (6) is having a flexible closure (8) adapted to be in an open position to allow the flow of the fluid on application of force onto an outer surface of the nipple (3), and to be in a closed position to disallow the flow of the fluid on removing the force onto the outer surface of the nipple (3); and
one or more air vents (10) to allow a flow of air into the nipple (3), and to disallow the flow of air out of the nipple (3) in order to prevent air bubbles from being formed inside the nipple (3);
a flow control mechanism (11) adapted to control flow of fluid from the cavity (2) of the first part into the nipple (3).

17. A method of using a feeding bottle comprising:
assembling a first part of the feeding bottle onto a second part of the feeding bottle, wherein the first part comprising a cavity adapted to hold a fluid, and the second part comprising a nipple having an opening, such that when the first part is coupled to the second part, the fluid is allowed to pass through the opening of the nipple, the nipple further comprising a tube which is placed within the nipple, a sealed end of the tube is coupled to the opening of the nipple, and a free end opposite to the sealed end is having a flexible closure adapted to be in an open position to allow the flow of the fluid on application of force onto an outer surface of the nipple, and to be in a closed position to disallow the flow of the fluid on removing the force onto the outer surface of the nipple;
placing the nipple of the bottle into a feeding position so that the fluid moves up to the nipple from the cavity.

18. The method according to the claim 17 comprising:
actuating a flow control mechanism using an actuator, for controlling flow of fluid from the cavity of the first part into the nipple.

19. The method according to claim 18 comprising:
locking the actuator using a lock coupled to the actuator.
